(19) United States
(12) Patent Application Publication
(10) Pub. No.: US 2023/0234470 A1
(43) Pub. Date: Jul. 27, 2023

(54) VEHICLE, METHOD FOR CALCULATING CRUISING RANGE OF VEHICLE, AND PROGRAM

(71) Applicant: HONDA MOTOR CO., LTD., Tokyo (JP)

(72) Inventor: Hiroshi TAGAMI, Tokyo (JP)

(73) Assignee: HONDA MOTOR CO., LTD., Tokyo (JP)

(21) Appl. No.: 18/101,315

(22) Filed: Jan. 25, 2023

(30) Foreign Application Priority Data
Jan. 26, 2022 (JP) 2022-010470

(51) Int. Cl. B60L 58/12

(52) U.S. Cl. CPC B60L 58/12; B60L 2260/52; B60L 2240/642; B60L 2240/12

(57) ABSTRACT

A vehicle includes an electric motor, a power storage device, and a control device. The control device is configured to acquire an electric power consumption and a traveling distance of the vehicle per unit time. The control device is configured to calculate the electricity consumption based on an integrated electric power consumption obtained by integrating the electric power consumption and an integrated traveling distance obtained by integrating the traveling distance. The control device is configured to determine whether a traveling state of the vehicle is a downhill traveling state or a non-downhill traveling state, and the control device is configured to limit improvement of the electricity consumption when the vehicle is in the downhill traveling state.

### CROSS-REFERENCE TO RELATED APPLICATIONS

This application is based on and claims priority under 35 USC 119 from Japanese Patent Application No. 2022-010470 filed on Jan. 26, 2022.

### TECHNICAL FIELD

The present disclosure relates to a vehicle, a method for calculating a cruising range of a vehicle, and a program.

### BACKGROUND ART

In recent years, efforts to implement a low-carbon society or a decarbonized society have been actively made. In a vehicle, a demand for reduced CO, emission leads to a rapid shift to electrification of a driving source. Specifically, a vehicle (hereinafter, also referred to as an “electric vehicle”) such as an electrical vehicle or a hybrid electrical vehicle, which includes an electric motor as a driving source and a power storage device capable of supplying electric power to the electric motor has been developed.

In general, in the electric vehicle, a cruising range is calculated based on an electricity consumption of the vehicle and a remaining electric power amount of the power storage device, and the calculated cruising range is presented to a user of the vehicle. The user determines timing when the power storage device is to be charged based on the presented cruising range, for example, in relation to a distance to a destination. In an electric vehicle which relies on a power storage device to power the entire vehicle, it is extremely important to appropriately calculate the cruising range.

According to a vehicle disclosed in Japanese Patent No. 5656736, a reference electricity consumption of the vehicle is determined based on an average vehicle speed in a certain period and an average driving force related to an amount of operation on an accelerator pedal, and the reference electricity consumption is multiplied by a modification factor so as to calculate a predicted electricity consumption used for calculation of a cruising range. The modification factor is a ratio of the reference electricity consumption to an actual electricity consumption in the same period, and is smoothed by taking into account a previous modification factor. The predicted electricity consumption calculated in this way reflects factors affecting the electricity consumption, such as a driving style of a user and a slope of a road surface, and reduces sudden increases or decreases.

During downhill traveling of a vehicle, a power storage device is charged with electric power regenerated by an electric motor. Since a traveling distance of the vehicle increases along with the charging of the power storage device, an electricity consumption during the downhill traveling is significantly improved as compared with an electricity consumption during level traveling or uphill traveling. If a downhill traveling state continues for a long time, the predicted electricity consumption disclosed in Patent Literature 1 becomes a value close to an actual electricity consumption during downhill traveling. Thereafter, when the vehicle is shifted to level traveling or uphill traveling after finishing the downhill traveling, it takes time until the predicted electricity consumption becomes a value close to an actual electricity consumption of the level traveling or the uphill traveling. As a result, the cruising range calculated based on the predicted electricity consumption after the shift to the level traveling or the uphill traveling may become excessively large with respect to a true cruising range, which lacks reliability.

### SUMMARY

The present disclosure proposes a vehicle, a calculation method, and a program for appropriately calculating a cruising range.

According to a first aspect of the present disclosure, there is provided a vehicle including: an electric motor configured to rotate a driving wheel of the vehicle; a power storage device which is configured to supply electric power to the electric motor and is chargeable with electric power regenerated by the electric motor; and a control device configured to calculate a cruising range of the vehicle based on an electricity consumption of the vehicle and a remaining electric power amount of the power storage device, and configured to execute a process of displaying the calculated cruising range, in which: the control device is configured to acquire an electric power consumption and a traveling distance of the vehicle per unit time; the control device is configured to calculate the electricity consumption based on an integrated electric power consumption obtained by integrating the electric power consumption and an integrated traveling distance obtained by integrating the traveling distance; and the control device is configured to determine whether a traveling state of the vehicle is a downhill traveling state or a non-downhill traveling state, and the control device is configured to limit improvement of the electricity consumption when the vehicle is in the downhill traveling state.

In addition, according to a second aspect of the present disclosure, there is provided a vehicle including: an electric motor configured to rotate a driving wheel of the vehicle; a power storage device which is configured to supply electric power to the electric motor and is chargeable with electric power regenerated by the electric motor; and a control device configured to calculate a cruising range of the vehicle based on an electricity consumption of the vehicle and a remaining electric power amount of the power storage device, and configured to execute a process of displaying the calculated cruising range, in which: the control device is configured to determine whether a traveling state of the vehicle is a downhill traveling state or a non-downhill traveling state; and the control device is configured to reduce the cruising range calculated when in the downhill traveling state to less than the cruising range calculated when in the non-downhill traveling state with respect to the same remaining electric power amount of the power storage device.

In addition, according to a third aspect of the present disclosure, there is provided a method for calculating a cruising range of a vehicle including an electric motor configured to rotate a driving wheel of the vehicle and a power storage device which is configured to supply electric power to the electric motor and is chargeable with electric power regenerated by the electric motor, the method including: causing a computer to perform: acquisition of an electric power consumption and a traveling distance of the vehicle per unit time; and calculation of an electricity consumption of the vehicle based on an integrated electric power consumption obtained by integrating the electric power consumption and an integrated traveling distance obtained by integrating the traveling distance, in which the calculation of the electricity consumption includes determining whether a traveling state of the vehicle is a downhill traveling state or a non-downhill traveling state and limiting improvement of the electricity consumption when the vehicle is in the downhill traveling state.

In addition, according to a fourth aspect of the present disclosure, there is provided a program configured to cause a computer to execute the above method.

According to the present disclosure, a cruising range of a vehicle can be appropriately calculated.

### BRIEF DESCRIPTION OF DRAWINGS

FIG. 1 illustrates a schematic configuration of an example of a vehicle for explaining an embodiment of the present disclosure.

FIG. 2 illustrates a schematic configuration related to calculation of a cruising range of the vehicle in FIG. 1.

FIG. 3 is a flowchart illustrating a basic process for explaining a calculation process of the cruising range.

FIG. 4 is a flowchart illustrating a calculation process of a virtual electric power consumption in FIG. 3.

FIG. 5 is a flowchart illustrating an example of a cruising range calculation process performed by a control device of the vehicle in FIG. 1.

FIG. 6 is a flowchart illustrating an example of the cruising range calculation process performed by the control device of the vehicle in FIG. 1.

FIG. 7 is a flowchart illustrating a traveling state determination process in FIG. 5.

FIG. 8 is a timing chart illustrating the cruising range calculation process illustrated in FIGS. 5 and 6 according to a traveling situation of the vehicle.

FIG. 9 is a flowchart illustrating another example of the cruising range calculation process performed by the control device of the vehicle in FIG. 1.

FIG. 10 is a flowchart illustrating another example of the cruising range calculation process performed by the control device of the vehicle in FIG. 1.

FIG. 11 is a graph illustrating an example of a table defining a relationship between a vehicle speed and a lower limit value set for an electric power consumption, which is used in a limiting process in FIG. 9.

FIG. 12 is a flowchart illustrating a modification of the traveling state determination process in FIG. 9.

FIG. 13 is a flowchart illustrating another modification of the traveling state determination process in FIG. 9.

FIG. 14 is a flowchart illustrating an example of a traveling distance calculation process in FIG. 13.

FIG. 15 is a graph illustrating an example of a table defining a relationship between a traveling distance and a first threshold value set for an integrated value of an electric power consumption, which is used in the traveling state determination process in FIG. 13.

FIG. 16 is a graph illustrating an example of a table defining a relationship between the traveling distance and a second threshold value set for the integrated value of the electric power consumption, which is used in the traveling state determination process in FIG. 13.

FIG. 17 is a timing chart illustrating the cruising range calculation process illustrated in FIGS. 9 and 10 according to the traveling situation of the vehicle.

### DESCRIPTION OF EMBODIMENTS

[Vehicle]

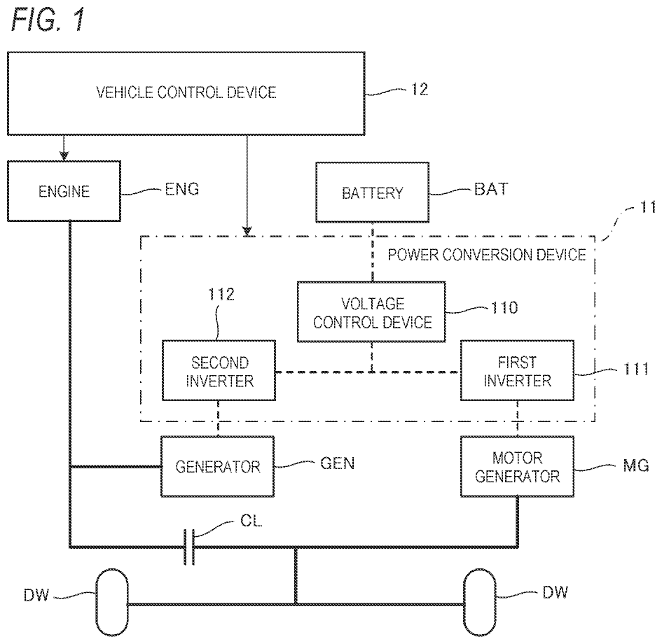

FIG. 1 illustrates a schematic configuration of an example of a vehicle for explaining an embodiment of the present disclosure.

As illustrated in FIG. 1, a vehicle 10 is a hybrid electric vehicle, and includes an engine ENG which is an example of an internal combustion engine, a motor generator MG which is an example of an electric motor, a generator GEN which is an example of a generator, a battery BAT which is an example of a power storage device, a clutch CL, a power conversion device 11, and a vehicle control device 12. In FIG. 1, a thick solid line indicates mechanical connection, a broken line indicates electric wiring, and a thin solid arrow indicates transmission and reception of a control signal.

The engine ENG is, for example, a gasoline engine or a diesel engine, and outputs power generated by burning supplied fuel. The engine ENG is connected to the generator GEN and is connected to a driving wheel DW of the vehicle 10 via the clutch CL. Power output from the engine ENG (hereinafter, also referred to as “output of the engine ENG”) is transmitted to the generator GEN when the clutch CL is in a disconnected state, and is transmitted to the driving wheel DW when the clutch CL is in a connected state (engaged state). The generator GEN and the clutch CL will be described later.

The motor generator MG is a motor generator (so-called traction motor) mainly used as a driving source of the vehicle 10, and is implemented by, for example, an AC motor. The motor generator MG is electrically connected to the battery BAT and the generator GEN via the power conversion device 11. At least one of electric power of the battery BAT and electric power of the generator GEN may be supplied to the motor generator MG. The motor generator MG operates as an electric motor by being supplied with electric power, and outputs power for the vehicle 10 to travel. In addition, the motor generator MG is connected to the driving wheel DW, and the power output from the motor generator MG (hereinafter, also referred to as “output of the motor generator MG”) is transmitted to the driving wheel DW. The vehicle 10 travels by transmitting at least one of the output of the engine ENG and the output of the motor generator MG to the driving wheel DW.

In addition, the motor generator MG performs a regenerative operation as a generator when the vehicle 10 is braked (when being rotated by the engine ENG or the driving wheel DW), and performs power generation (so-called regenerative power generation). Electric power generated by the regenerative operation of the motor generator MG (hereinafter, also referred to as “regenerative electric power”) is supplied to the battery BAT via the electric power conversion device 11, for example. Accordingly, the battery BAT can be charged by the regenerative electric power.

The generator GEN is mainly used as a generator, and is implemented by, for example, an AC motor. The generator GEN is driven by the power of the engine ENG to generate electric power. The electric power generated by the generator GEN is supplied to at least one of the battery BAT and the motor generator MG via the power conversion device 11. By supplying the electric power generated by the generator GEN to the battery BAT, the battery BAT can be charged by the electric power. In addition, by supplying the electric power generated by the generator GEN to the motor generator MG, the motor generator MG can be driven by the electric power.

The power conversion device 11 is a device which converts input electric power and outputs the converted electric power (so-called power control unit), and is connected to the motor generator MG, the generator GEN, and the battery BAT. For example, the power conversion device 11 includes a first inverter 111, a second inverter 112, and a voltage control device 110. The first inverter 111, the second inverter 112, and the voltage control device 110 are electrically connected to each other.

The voltage control device 110 converts an input voltage and outputs the converted voltage. As the voltage control device 110, a DC/DC converter or the like can be used. For example, when electric power of the battery BAT is supplied to the motor generator MG, the voltage control device 110 boosts an output voltage of the battery BAT and outputs the boosted voltage to the first inverter 111. In addition, for example, when regenerative power generation is performed by the motor generator MG, the voltage control device 110 steps down an output voltage of the motor generator MG received via the first inverter 111 and outputs the stepped-down voltage to the battery BAT. In addition, when the generator GEN generates electric power, the voltage control device 110 steps down an output voltage of the generator GEN received via the second inverter 112 and outputs the stepped-down voltage to the battery BAT

When electric power of the battery BAT is supplied to the motor generator MG, the first inverter 111 converts the electric power (direct current) of the battery BAT received via the voltage control device 110 into an alternating current and outputs the alternating current to the motor generator MG. In addition, when regenerative power generation is performed by the motor generator MG, the first inverter 111 converts electric power (alternating current) received from the motor generator MG into a direct current and outputs the direct current to the voltage control device 110. When the generator GEN generates electric power, the second inverter 112 converts electric power (alternating current) received from the generator GEN into a direct current and outputs the direct current to the voltage control device 110.

The battery BAT is a chargeable and dischargeable secondary battery, and includes a plurality of power storage cells connected in series or in series-parallel. The battery BAT is configured to be capable of outputting a high voltage of, for example, 100 to 400 [V]. As each power storage cell of the battery BAT, a lithium ion battery, a nickel hydrogen battery, or the like can be used.

The clutch CL can be in the connected state in which a power transmission path from the engine ENG to the driving wheel DW is connected (engaged), and the disconnected state in which the power transmission path from the engine ENG to the driving wheel DW is disconnected (shut off). The output of the engine ENG is transmitted to the driving wheel DW when the clutch CL is in the connected state, and is not transmitted to the driving wheel DW when the clutch CL is in the disconnected state.

The vehicle control device 12 is, for example, a device (computer) which is implemented by an electronic control unit (ECU) including a processor which performs various types of calculation, a storage device which stores various types of information, an input and output device which controls input and output of data between inside and outside of the vehicle control device 12, and the like, and performs overall control of the entire vehicle 10. The vehicle control device 12 may be implemented by one ECU or may be implemented by a plurality of ECUs.

Specifically, the vehicle control device 12 is provided so as to be communicable with the engine ENG, the clutch CL, and the power conversion device 11. The vehicle control device 12 controls the output of the engine ENG, controls output of the motor generator MG and the generator GEN by controlling the power conversion device 11, and controls the state of the clutch CL. Accordingly, the vehicle control device 12 can control a traveling mode of the vehicle 10 as described later.

[Vehicle Traveling Mode]

Next, traveling modes of the vehicle 10 will be described. As the traveling modes, the vehicle 10 may have an EV traveling mode, a hybrid traveling mode, and an engine traveling mode. The vehicle 10 travels in one of such traveling modes. Which driving mode the vehicle 10 is to travel in is controlled by the vehicle control device 12.

[EV Traveling Mode]

The EV traveling mode is a traveling mode in which only electric power of the battery BAT is supplied to the motor generator MG, and the vehicle 10 travels by power output by the motor generator MG in response to the electric power.

In the EV traveling mode, the vehicle control device 12 brings the clutch CL into the disconnected state. In addition, in the EV traveling mode, the vehicle control device 12 stops supply of fuel to the engine ENG and stops output of power from the engine ENG (hereinafter, also referred to as an “operation of the engine ENG”). Therefore, in the EV traveling mode, power generation by the generator GEN is not performed. In the EV traveling mode, the vehicle control device 12 supplies only the electric power of the battery BAT to the motor generator MG, causes the motor generator MG to output power corresponding to the electric power, and causes the vehicle 10 to travel by the power.

For example, the vehicle control device 12 causes the vehicle 10 to travel in the EV traveling mode under conditions that only the electric power from the battery BAT is supplied to the motor generator MG, and a driving force required for the vehicle 10 to travel (hereinafter, also referred to as a “required driving force”) is obtained by the power output by the motor generator MG in response to the electric power.

In the EV traveling mode, since the supply of fuel to the engine ENG is stopped, fuel consumed by the engine ENG is reduced and a fuel consumption of the vehicle 10 is improved as compared with the other traveling modes in which fuel is supplied to the engine ENG. Therefore, by increasing a frequency (opportunity) at which the vehicle 10 is set to the EV traveling mode, it is possible to improve the fuel consumption of the vehicle 10. On the other hand, in the EV traveling mode, the power generation by the generator GEN is not performed, and the motor generator MG is driven only by the electric power of the battery BAT, so that a remaining electric power amount (also called a state of charge (SOC)) of the battery BAT is likely to decrease.

[Hybrid Traveling Mode]

The hybrid traveling mode is a traveling mode in which at least electric power generated by the generator GEN is supplied to the motor generator MG, and the vehicle 10 travels mainly by power output by the motor generator MG in response to the electric power.

In the hybrid traveling mode, the vehicle control device 12 brings the clutch CL into the disconnected state. In addition, in the hybrid traveling mode, the vehicle control device 12 supplies fuel to the engine ENG, causes the engine ENG to output power, and drives the generator GEN by the power of the engine ENG. Accordingly, in the hybrid traveling mode, the generator GEN generates electric power. In addition, in the hybrid traveling mode, the vehicle control device 12 sets the power transmission path to the disconnected state by the clutch CL, supplies the electric power generated by the generator GEN to the motor generator MG, causes the motor generator MG to output power in response to the electric power, and causes the vehicle 10 to travel by the power.

The electric power supplied from the generator GEN to the motor generator MG is larger than the electric power supplied from the battery BAT to the motor generator MG. Therefore, in the hybrid traveling mode, the output of the motor generator MG can be increased as compared with the EV traveling mode, and a large driving force can be obtained as a driving force causing the vehicle 10 to travel (hereinafter, also referred to as “output of the vehicle 10”).

In the case of the hybrid traveling mode, the vehicle control device 12 may also supply the electric power of the battery BAT to the motor generator MG as necessary. That is, the vehicle control device 12 may supply the electric power of both the generator GEN and the battery BAT to the motor generator MG in the hybrid traveling mode. Accordingly, the electric power supplied to the motor generator MG can be increased as compared with the case where only the electric power of the generator GEN is supplied to the motor generator MG, and a larger driving force can be obtained as the output of the vehicle 10.

[Engine Traveling Mode]

The engine traveling mode is a traveling mode in which the vehicle 10 travels mainly by power output from the engine ENG.

In the engine traveling mode, the vehicle control device 12 brings the clutch CL into the connected state. In addition, in the engine traveling mode, the vehicle control device 12 supplies fuel to the engine ENG so as to output power from the engine ENG. In the engine traveling mode, since the power transmission path is brought into the connected state by the clutch CL, the power of the engine ENG is transmitted to the driving wheel DW to drive the driving wheel DW. In this way, in the engine traveling mode, the vehicle control device 12 outputs power from the engine ENG and causes the vehicle 10 to travel by the power.

In addition, in the engine traveling mode, the vehicle control device 12 may supply the electric power of the battery BAT to the motor generator MG as necessary. Accordingly, in the engine traveling mode, the vehicle 10 can travel by also using power output by the motor generator MG due to the supply of the electric power of the battery BAT, and as compared with a case where the vehicle 10 travels only by the power of the engine ENG, a larger driving force can be obtained as the output of the vehicle 10. Accordingly, the output of the engine ENG can be reduced and the fuel consumption of the vehicle 10 can be improved as compared with the case where the vehicle 10 travels only by the power of the engine ENG.

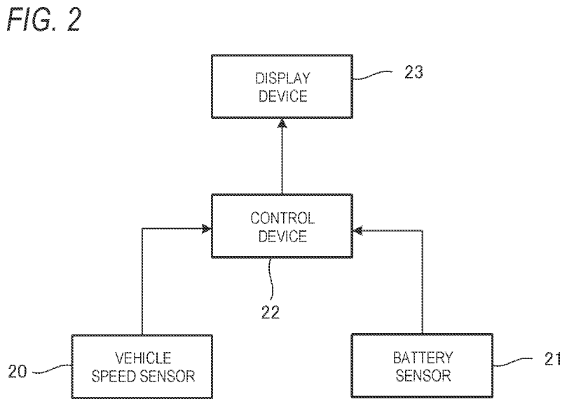

FIG. 2 illustrates a schematic configuration related to calculation of a cruising range of the vehicle 10.

The vehicle 10 includes a vehicle speed sensor 20 which detects a traveling speed (hereinafter, also referred to as a “vehicle speed”) of the vehicle 10, a battery sensor 21 which detects a charge/discharge current, a charge/discharge voltage, a temperature, and the like of the battery BAT, a control device 22, and a display device 23. Detection results detected by the vehicle speed sensor 20 and the battery sensor 21 are transmitted to the control device 22.

The control device 22 is implemented by an ECU including a processor which performs various types of calculation, a storage device which stores various types of information, an input and output device which controls input and output of data between inside and outside of the vehicle control device 12, and the like. The control device 22 may also be configured as a part of the vehicle control device 12.

The control device 22 acquires a traveling distance per unit time based on the detection result of the vehicle speed sensor 20, and calculates an integrated traveling distance obtained by integrating the traveling distance. In addition, the control device 22 acquires an electric power consumption per unit time of the vehicle 10 based on the detection result of the battery sensor 21, and calculates an integrated electric power consumption obtained by integrating the electric power consumption. Then, the control device 22 calculates an electricity consumption of the vehicle 10 by using the integrated traveling distance and the integrated electric power consumption, and calculates the cruising range of the vehicle 10 based on the electricity consumption and the remaining electric power amount of the battery BAT. The remaining electric power amount of the battery BAT is estimated by the vehicle control device 12 or the control device 22 based on the detection result of the battery sensor 21.

Then, the control device 22 displays the calculated cruising range on the display device 23. The display device 23 is a display device capable of displaying various types of information related to the vehicle 10, such as a liquid crystal display called a “multi-information display”, and is installed in an instrument panel of the vehicle 10. A user can determine timing when the battery BAT is to be charged based on the cruising range displayed on the display device 23, for example, in relation to a distance to a destination. The display device 23 is not limited to the liquid crystal display installed in the instrument panel of the vehicle 10, and may be a smartphone or the like carried by the user.

Next, a calculation process of the cruising range of the vehicle 10 performed by the control device 22 will be described. Although the vehicle 10 is a hybrid electric vehicle including the engine ENG, the process described below can be applied to a vehicle capable of traveling only by electric power of a battery, and can also be applied to, for example, an electric vehicle including no engine (battery electric vehicle).

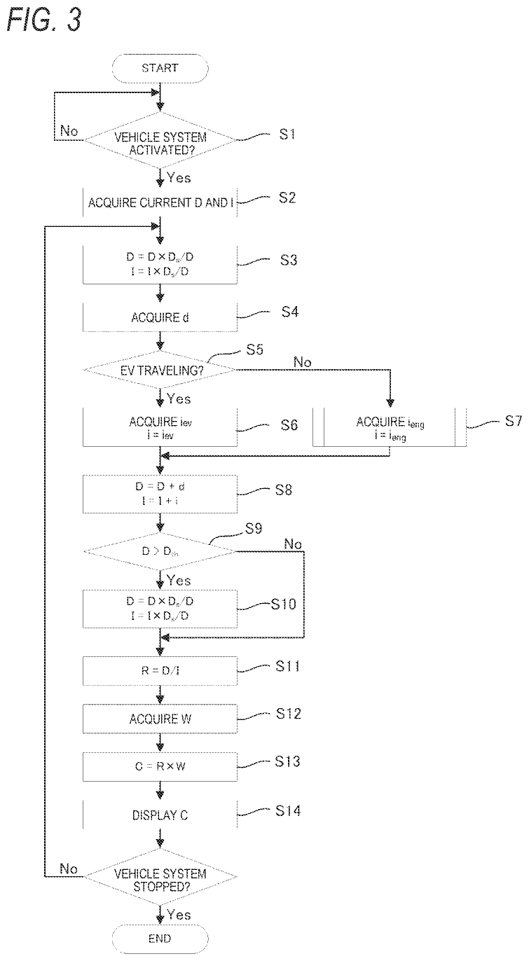

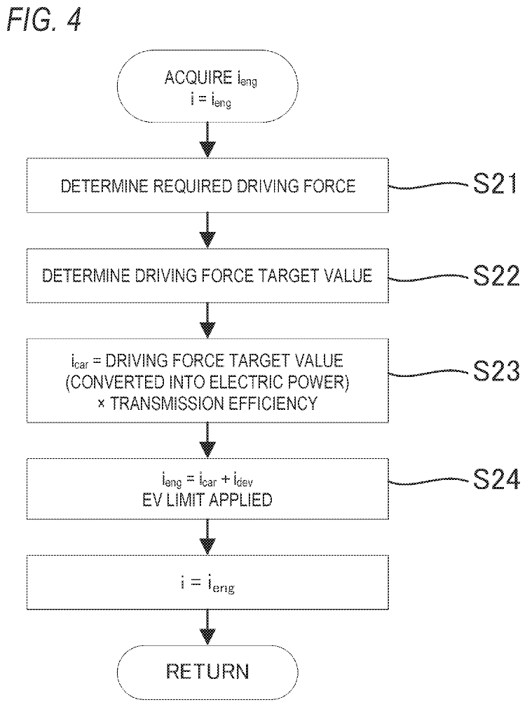

FIGS. 3 and 4 illustrate a basic process for explaining the cruising range calculation process performed by the control device 22.

When a vehicle system of the vehicle 10 is activated (Yes in step S1), the control device 22 acquires a current integrated traveling distance D and a current integrated electric power consumption I (step S2). The integrated traveling distance D and the integrated electric power consumption I are stored in the storage device of the vehicle control device 12 or the control device 22.

The control device 22 enlarges or reduces the acquired integrated traveling distance D to a predetermined value Dₛ, and enlarges or reduces the acquired integrated electric power consumption I by the same ratio Dₛ/D as that of the integrated traveling distance D according to the following formulas (step S3). The predetermined value Dₛ is set in consideration of a standard traveling distance of the vehicle 10 per unit time (for example, 6 km to 7 km in 10 minutes).

D=D×(Dₛ/D)

I=I=(Dₛ/D)

Then, the control device 22 acquires a latest traveling distance d per unit time (step S4). The enlargement or reduction process of the integrated traveling distance D and the integrated electric power consumption I in step S3 is weighting of the integrated traveling distance D and the integrated electric power consumption I. By this weighting, in the calculation of the electricity consumption to be described later, an influence of the latest traveling distance d per unit time and the electric power consumption on the electricity consumption can be equalized regardless of the integrated traveling distance D and the integrated electric power consumption I.

Next, the control device 22 determines whether the traveling mode of the vehicle 10 is the EV traveling mode (step S5). When the traveling mode is the EV traveling mode (Yes in step S5), the control device 22 acquires an electric power consumption iₑᵥ per unit time of the vehicle 10, and sets the acquired as the latest electric power consumption i per unit time (step S6). In addition, when the traveling mode is not the EV traveling mode, that is, when the traveling mode is the hybrid traveling mode or the engine traveling mode (No in step S5), the control device 22 calculates a virtual electric power consumption i_{eng}, and sets the calculated i_{eng} as the latest electric power consumption i per unit time (step S7).

FIG. 4 illustrates a calculation process of the virtual electric power consumption i_{eng}.

The control device 22 determines the required driving force based on an amount of operation performed on an accelerator pedal and the vehicle speed of the vehicle 10 with reference to a driving force map (step S21). The driving force map defines a relationship between the amount of operation performed on the accelerator pedal, the vehicle speed, and the required driving force, and is stored in advance in the storage device of the control device 22. Then, the control device 22 determines a driving force target value by applying various limits to the required driving force determined in step S21 (step S22).

Next, the control device 22 obtains a driving electric power consumption i_{car} by converting a value obtained by multiplying the driving force target value determined in step S22 by a transmission efficiency into electric power (step S23). Then, the control device 22 adds an auxiliary device electric power consumption i_{dev} consumed by an auxiliary device such as an air conditioner to the driving electric power consumption i_{car}, and applies an EV limit to a sum of the driving electric power consumption i_{car} and the auxiliary device electric power consumption i_{dev} so as to obtain the virtual electric power consumption i_{eng} (step S24). The EV limit defines an upper limit of electric power which can be supplied by the battery BAT in relation to the temperature of the battery BAT, for example.

The processes of step S5 and step S7 are omitted when the vehicle 10 is an electric vehicle including no engine.

Referring again to FIG. 3, the control device 22 integrates the traveling distance d acquired in step S4 with the weighted integrated traveling distance D. In addition, the control device 22 integrates the electric power consumption i acquired in step S6 or step S7 with the weighted integrated electric power consumption I (step S8).

Next, the control device 22 determines whether the integrated traveling distance D obtained in step S8 exceeds a predetermined threshold value Dₜₕ (step S9). The threshold value Dₜₕ is appropriately set in consideration of the predetermined value Dₛ and the standard traveling distance of the vehicle 10 per unit time. When the integrated traveling distance D exceeds the predetermined threshold value Dₜₕ (Yes in step S9), the control device 22 enlarges or reduces the integrated traveling distance D to the predetermined value Dₛ, and enlarges or reduces the integrated electric power consumption I by the same ratio Dₛ/D as that of the integrated traveling distance D (step S10).

When the integrated traveling distance D obtained in step S8 is equal to or less than the threshold value Dₜₕ, the control device 22 calculates an electricity consumption R according to the following formula based on the integrated traveling distance D and the integrated electric power consumption I obtained in step S8, and when the integrated traveling distance D obtained in step S8 exceeds the threshold value Dₜₕ, the control device 22 calculates the electricity consumption R according to the following formula based on the integrated traveling distance D and the integrated electric power consumption I obtained in step S10 (step S11).

R (km/Wh)=D (km)/I(Wh)

Next, the control device 22 acquires a remaining electric power amount W of the battery BAT (step S12), and calculates a cruising range C of the vehicle 10 according to the following formula based on the electricity consumption R obtained in step S11 and the remaining electric power amount W (step S13). Then, the control device 22 displays the calculated cruising range C on the display device 23 (step S14).

C (km)=R (km/Wh)×W (Wh)

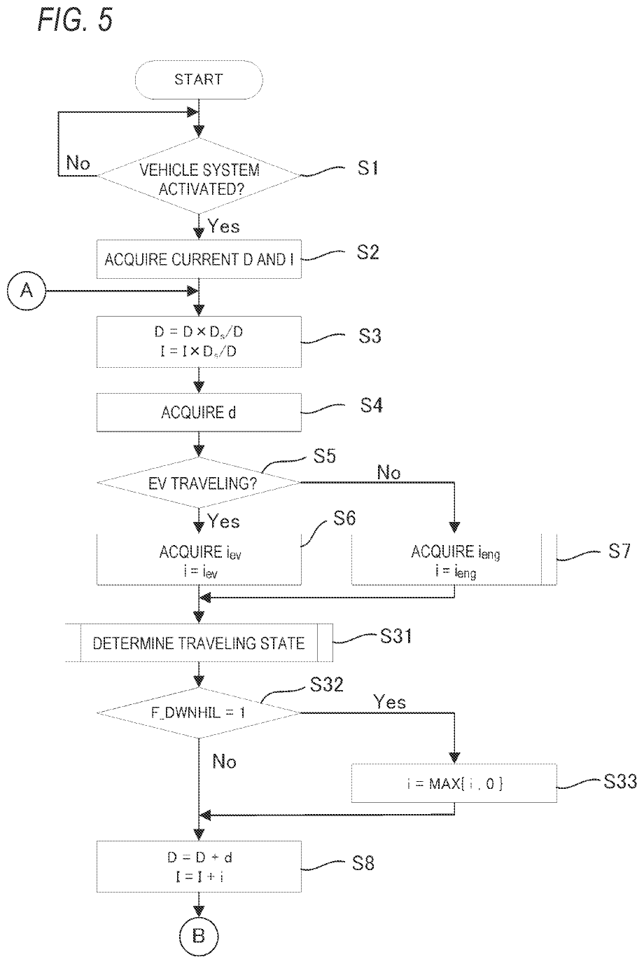

FIGS. 5 to 7 illustrate an example of a cruising range calculation process performed by the control device 22.

In the example illustrated in FIGS. 5 to 7, a process of determining whether the traveling state of the vehicle 10 is a downhill traveling state or a non-downhill traveling state and a process of limiting improvement of the electricity consumption R when the vehicle 10 is in the downhill traveling state are added to the basic process described above.

After acquiring the traveling distance d in step S4 and acquiring the electric power consumption i in step S6 or step S7, the control device 22 determines whether the travel state of the vehicle 10 is the downhill traveling state or the non-downhill traveling state (step S31).

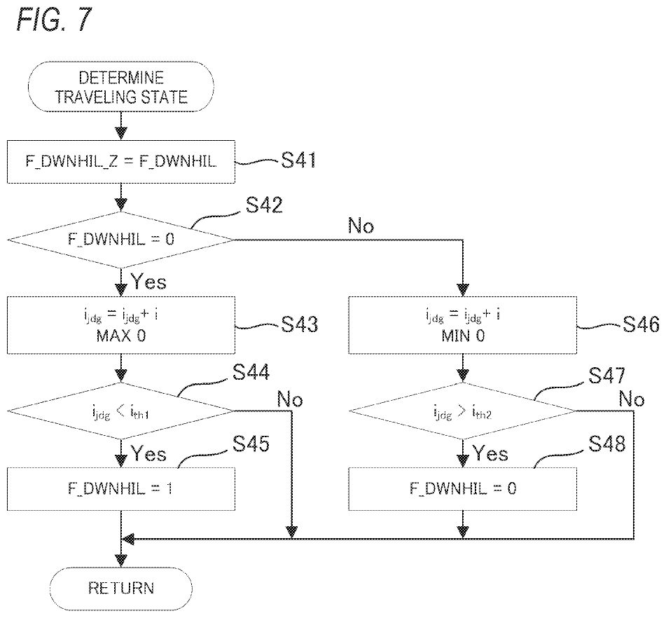

FIG. 7 illustrates a traveling state determination process.

First, the control device 22 holds a value of a state flag F_DWNHIL related to the traveling state of the vehicle 10 as a previous value in F_DWNHIL_Z (step S41). Then, the control device 22 acquires the traveling state of the vehicle 10 based on the value of the state flag F_DWNHIL (step S42). In the following description, F_DWNHIL=1 means that the vehicle 10 is in the downhill traveling state, and F_DWNHIL=0 means that the vehicle 10 is in the non-downhill traveling state.

When the traveling state of the vehicle 10 is the non-downhill traveling state (Yes in step S42), the control device 22 integrates the electric power consumption i acquired in step S6 or step S7 with a determination electric power consumption i_{jdg} (step S43). The determination electric power consumption i_{jdg} is obtained by integrating the electric power consumption i in a period in which the vehicle 10 continues the same traveling state, and is reset to zero when the traveling state shifts from the non-downhill traveling state to the downhill traveling state or when the traveling state shifts from the downhill traveling state to the non-downhill traveling state.

Here, in the non-downhill traveling state, that is, a level traveling state or an uphill traveling state, the vehicle 10 travels while consuming electric power of the battery BAT, and the electric power consumption i is basically zero or more. On the other hand, in the downhill traveling state, the battery BAT is charged by regenerative electric power, and thus the electric power consumption i may be equal to or less than zero. When the shift from the non-downhill traveling state to the downhill traveling state is detected, in the integration of the electric power consumption i in step S43, the electric power consumption i may be integrated with the determination electric power consumption i_{jdg} in a range of zero or less.

When the determination electric power consumption i_{jdg} is less than a first threshold value iₜₕ₁ (Yes in step S44), the control device 22 detects the shift from the non-downhill traveling state to the downhill traveling state, and sets the value of the state flag F_DWNHIL to “1” (step S45). The first threshold value iₜₕ₁ is appropriately set to a value less than zero such that the traveling state does not shift to the downhill traveling state due to short-time deceleration regeneration or traveling on a short-distance downhill road.

On the other hand, when the traveling state of the vehicle 10 is the downhill traveling state (No in step S42), the control device 22 integrates the electric power consumption i acquired in step S6 or step S7 with the determination electric power consumption i_{jdg} (step S46). As described above, in the non-downhill traveling state, the electric power consumption i is basically equal to or higher than zero. Therefore, when the shift from the downhill traveling state to the non-downhill traveling state is detected, in the integration of the electric power consumption i in step S46, the electric power consumption i may be integrated with the determination electric power consumption i_{jdg} in a range of zero or more.

When the determination electric power consumption i_{jdg} exceeds a second threshold value iₜₕ₂ (Yes in step S47), the control device 22 detects the shift from the downhill traveling state to the non-downhill traveling state, and sets the value of the state flag F_DWNHIL to “0” (step S48). The second threshold value iₜₕ₂ is appropriately set to a value larger than zero such that the traveling state does not shift to the non-downhill traveling state due to short-time acceleration or traveling on a short-distance uphill road.

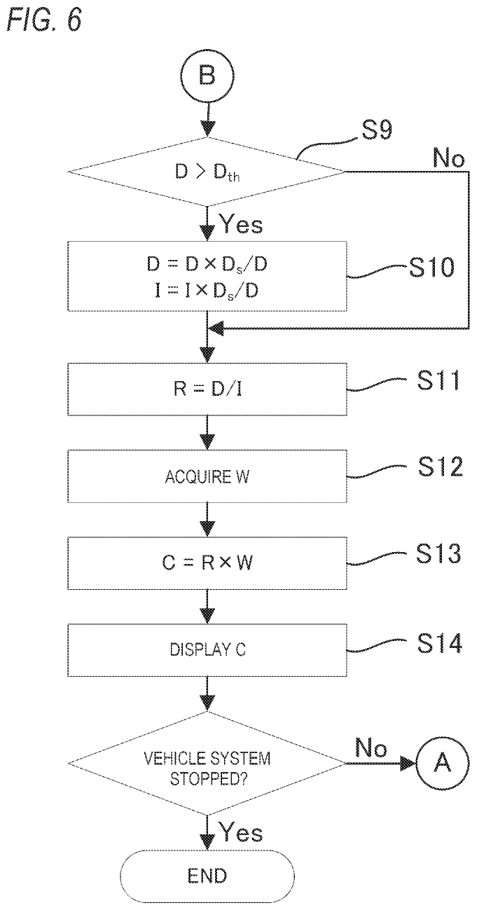

Referring again to FIG. 5, as a result of the determination in step S31, when the traveling state of the vehicle 10 is the non-downhill traveling state (No in step S32), the control device 22 integrates the electric power consumption i acquired in step S6 or step S7 with the weighted integrated electric power consumption I (step S8). Then, as illustrated in FIG. 6, the control device 22 calculates the electricity consumption R, calculates the cruising range C, and displays the calculated cruising range C on the display device 23 according to the processes of step S9 to step S14 described above.

On the other hand, as a result of the determination in step S31, when the traveling state of the vehicle 10 is the downhill traveling state (Yes in step S32), the control device 22 applies a limit to the electric power consumption i acquired in step S6 or step S7 (step S33), and integrates the electric power consumption i after the limit application with the weighted integrated electric power consumption I (step S8).

In the limiting process of step S33, the control device 22 sets a larger one of the electric power consumption i acquired in step S6 or step S7 and a lower limit value set for the electric power consumption i as the electric power consumption to be integrated with the integrated electric power consumption I. As described above, the lower limit value is set to zero in the present example in consideration of the fact that the electric power consumption i in the downhill traveling state may be equal to or less than zero. For example, when the electric power consumption i acquired in step S6 or step S7 is zero or a positive value, the electric power consumption i acquired in step S6 or step S7 is directly integrated with the integrated electric power consumption I. On the other hand, when the electric power consumption i acquired in step S6 or step S7 is a negative value, zero is integrated with the integrated electric power consumption I.

Then, the control device 22 calculates the electricity consumption R, calculates the cruising range C, and displays the calculated cruising range C on the display device 23 according to the processes of step S9 to step S14 described above.

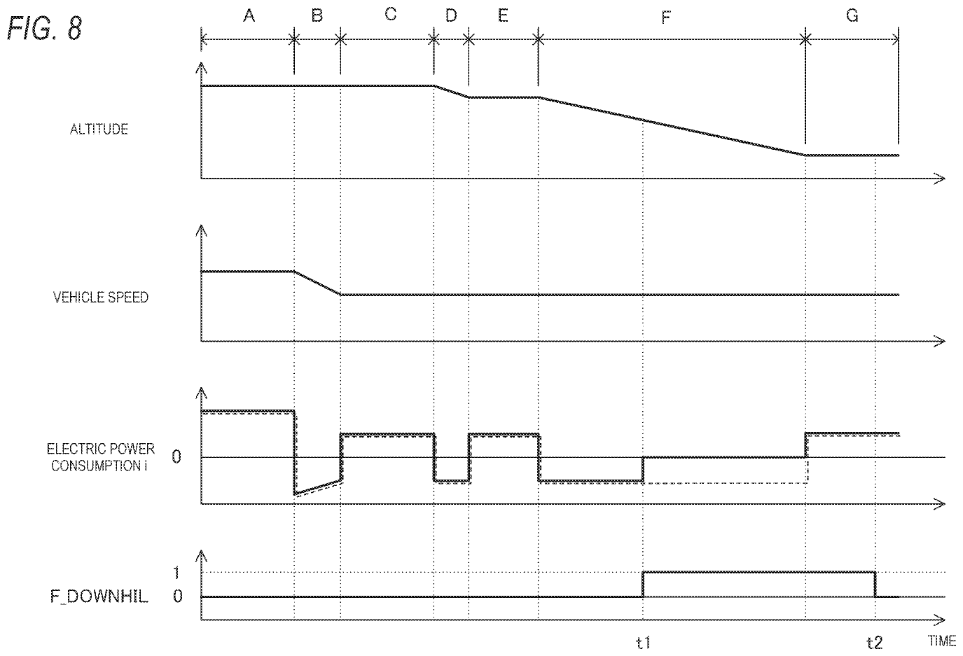

FIG. 8 is a timing chart illustrating the cruising range calculation process illustrated in FIGS. 5 to 7 according to a traveling situation of the vehicle. In a graph illustrating a change in the electric power consumption i per unit time, a solid line indicates the electric power consumption i after the limit is applied in step S33, and a broken line indicates the electric power consumption i acquired in step S6 or step S7.

Sections A to E are level sections (level roads) of a relatively long distance as a whole, which include the relatively short downhill section D. A section F is a downhill section (downhill road) of a relatively long distance. A section G is a level road. In addition, in the section B, the vehicle 10 decelerates.

In the sections A to E, the electric power consumption i acquired in step S6 or step S7 is basically a positive value, whereas in the section B in which the vehicle 10 decelerates and in the relatively short downhill section D, the electric power consumption i is temporarily a negative value. On the other hand, in the section F, the electric power consumption i acquired in step S6 or step S7 is constantly a negative value. The first threshold value iₜₕ₁ in the traveling state determination process described above is set to a value smaller than an integrated value of the electric power consumption i in the section B and the section D and larger than an integrated value of the electric power consumption i in the section F. Accordingly, in the traveling state determination process illustrated in FIG. 7, the shift to the downhill traveling state is not detected due to the short-time deceleration regeneration in the section B or the short-distance downhill traveling in the section D, and the traveling state of the vehicle 10 is maintained in the non-downhill traveling state over the sections A to E. Then, in the section F, the shift to the downhill traveling state is detected at time t1.

In this way, by determining the traveling state of the vehicle 10 based on the determination electric power consumption i_{jdg} obtained by integrating the electric power consumption i, it is possible to accurately distinguish between short-time deceleration on a level road or an uphill road, or traveling on a downhill road of a relatively short distance, and downhill traveling with a small calculation load. Similarly, short-time acceleration on a downhill road or traveling on a level or uphill road of a relatively short distance, and traveling on a level road or uphill road can be distinguished accurately with a small calculation load.

The traveling state of the vehicle 10 is determined to be the downhill traveling state by the control device 22 during a period from when the shift to the downhill traveling state is detected at the time t1 to when the shift to the non-downhill traveling state is detected at time t2 in the section G which is a level road. In the downhill traveling state, the limit is applied to the electric power consumption i acquired in step S6 or step S7, and the larger one of the electric power consumption i and the lower limit value (zero here) set for the electric power consumption i is integrated with the integrated electric power consumption I. Although the electric power consumption i in the section F is a negative value, zero is integrated with the integrated electric power consumption I by applying the limit after the time t1.

While the downhill traveling state continues, originally, the integrated traveling distance D gradually increases and the integrated electric power consumption I gradually decreases, whereas the integrated electric power consumption I is maintained at least without decreasing due to the above process. Therefore, improvement of the electricity consumption R (R=D/I) is limited. Accordingly, it is possible to prevent the cruising range calculated when the vehicle travels on a level road or an uphill road after passing a downhill road from becoming excessively large with respect to a true cruising range.

Limiting the improvement of the electricity consumption R (R=D/I) when the traveling state of the vehicle 10 is the downhill traveling state can be rephrased as making the cruising range C (C=R×W) calculated in the downhill traveling state smaller than the cruising range calculated in the non-downhill traveling state with respect to the same remaining electric power amount W of the battery BAT.

Instead of the determination electric power consumption i_{jdg} obtained by integrating the electric power consumption i, the traveling state of the vehicle may be determined based on whether the electric power consumption i is less than a predetermined value (for example, less than zero).

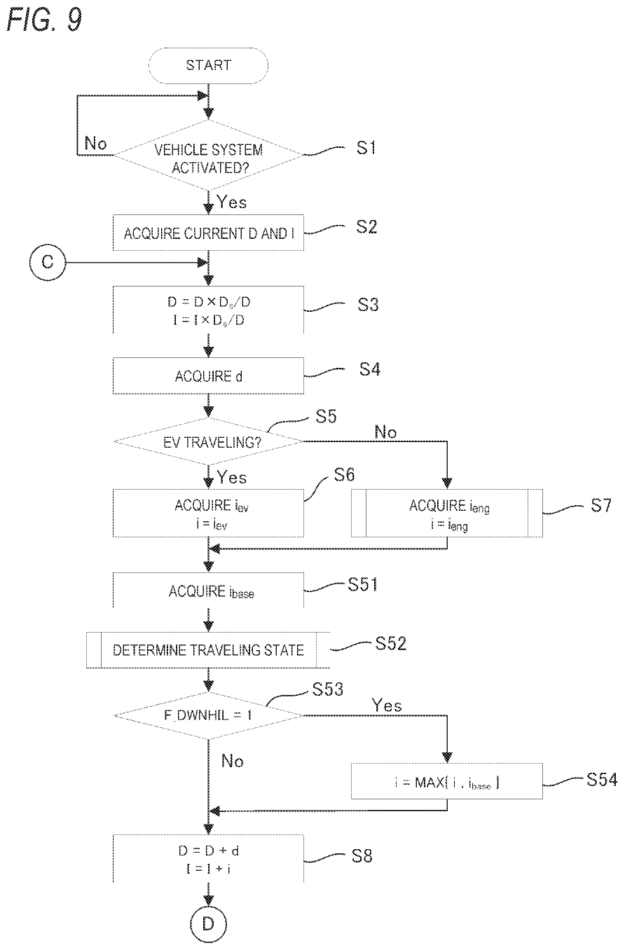

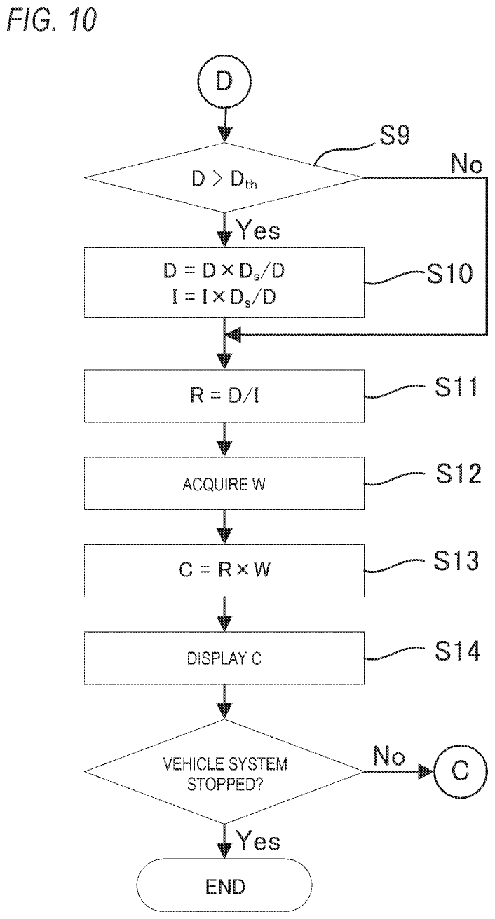

FIGS. 9 and 10 illustrate another example of the cruising range calculation process performed by the control device 22.

Traveling resistance of the vehicle increases as the vehicle speed increases mainly due to an influence of air resistance, and the electricity consumption deteriorates as the vehicle speed increases due to an increase in the traveling resistance. In the example illustrated in FIGS. 5 to 7, the lower limit value in the limiting process of the electric power consumption i is set to zero (fixed value), and the integrated electric power consumption I is maintained at least without decreasing, whereas the integrated traveling distance D increases greatly as the vehicle speed increases. As a result, when the vehicle speed is high, limitation on the improvement of the electricity consumption R (R=D/I) may be weakened. In the example illustrated in FIGS. 9 and 10, in the limiting process of the electric power consumption i, the lower limit value set for the electric power consumption i is changed according to the vehicle speed.

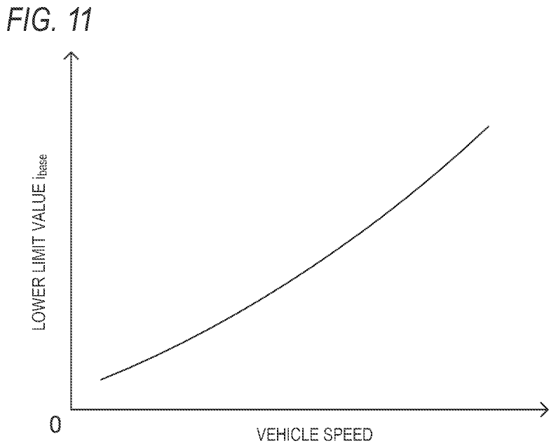

The storage device of the control device 22 stores in advance a table which defines a relationship between the vehicle speed and a lower limit value i_{base} set for the electric power consumption i. FIG. 11 illustrates an example of the table, in which the lower limit value it monotonically increases as the vehicle speed increases. This is a typical relationship between the vehicle speed and the electric power consumption per unit time required only for traveling when the vehicle travels on a level road.

As illustrated in FIG. 9, the control device 22 refers to the table and acquires the lower limit value i_{base} corresponding to the vehicle speed (step S51). Then, the control device 22 determines whether the traveling state of the vehicle 10 is the downhill traveling state or the non-downhill traveling state (step S52). The traveling state determination process of step S52 is the same as the traveling state determination process illustrated in FIG. 7.

As a result of the determination in step S52, when the traveling state of the vehicle 10 is the non-downhill traveling state (No in step S53), the control device 22 integrates the electric power consumption i acquired in step S6 or step S7 with the weighted integrated electric power consumption I (step S8). Then, as illustrated in FIG. 10, the control device 22 calculates the electricity consumption R, calculates the cruising range C, and displays the calculated cruising range C on the display device 23 according to the processes of step S9 to step S14 described above.

On the other hand, as a result of the determination in step S52, when the traveling state of the vehicle 10 is the downhill traveling state (Yes in step S53), the control device 22 applies the limit to the electric power consumption i acquired in step S6 or step S7 (step S54), and integrates the electric power consumption i after the limit application with the weighted integrated electric power consumption I (step S8).

In the limiting process of step S54, the control device 22 sets a larger one of the electric power consumption i acquired in step S6 or step S7 and the lower limit value i_{base} corresponding to the vehicle speed as the electric power consumption to be integrated with the integrated electric power consumption I. Then, the control device 22 calculates the electricity consumption R, calculates the cruising range C, and displays the calculated cruising range C on the display device 23 according to the processes of step S9 to step S14 described above.

According to the present example, in the limiting process of the electric power consumption i, the lower limit value set for the electric power consumption i changes according to the vehicle speed. Accordingly, it is possible to appropriately calculate the cruising range even when the vehicle speed is high.

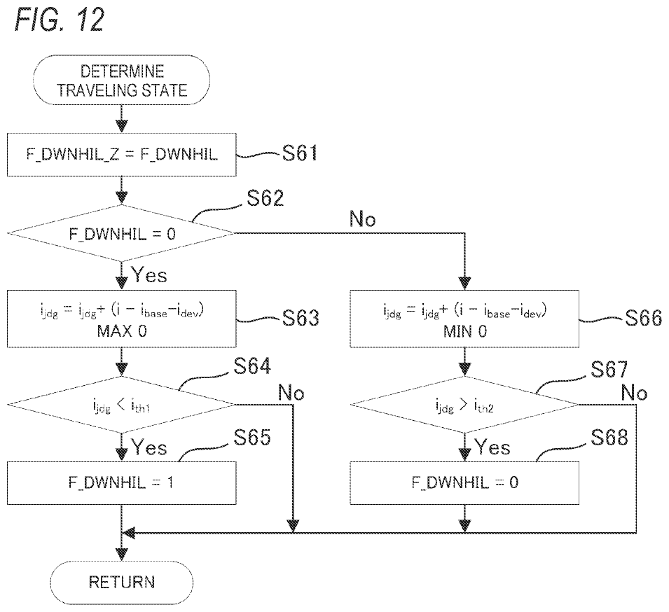

FIG. 12 illustrates a modification of the traveling state determination process in the cruising range calculation process illustrated in FIGS. 9 and 10.

First, the control device 22 holds the value of the state flag F_DWNHIL related to the traveling state of the vehicle 10 as the previous value in F_DWNHIL_Z (step S61). Then, the control device 22 acquires the traveling state of the vehicle 10 based on the value of the state flag F_DWNHIL (step S62).

When the traveling state of the vehicle 10 is the non-downhill traveling state (Yes in step S62), the control device 22 integrates a value obtained by subtracting the lower limit value i_{base} acquired in step S51 from the electric power consumption i acquired in step S6 or step S7 with the determination electric power consumption i_{jdg} in a range of zero or less (step S63). Here, since the electric power consumption i acquired in step S6 or step S7 includes the auxiliary device electric power consumption i_{dev} consumed by the auxiliary device, preferably, a value obtained by subtracting the auxiliary device electric power consumption i_{dev} and the lower limit value i_{base} from the electric power consumption i is integrated with the determination electric power consumption i_{jdg} in a range of zero or less.

When the determination electric power consumption i_{jdg} is less than the first threshold value iₜₕ₁ (Yes in step S64), the control device 22 detects the shift from the non-downhill traveling state to the downhill traveling state, and sets the value of the state flag F_DWNHIL to “1” (step S65).

On the other hand, when the traveling state of the vehicle 10 is the downhill traveling state (No in step S62), the control device 22 integrates a value obtained by subtracting the lower limit value i_{base} acquired in step S51 from the electric power consumption i acquired in step S6 or step S7 with the determination electric power consumption i_{jdg} in a range of zero or more (step S66). Preferably, the value obtained by subtracting the auxiliary device electric power consumption ide, and the lower limit value i_{base} from the electric power consumption i is integrated with the determination electric power consumption i_{jdg} in a range of zero or more.

When the determination electric power consumption i_{jdg} exceeds the second threshold value iₜₕ₂ (Yes in step S67), the control device 22 detects the shift from the downhill traveling state to the non-downhill traveling state, and sets the value of the state flag F_DWNHIL to “0” (step S68).

According to the present modification, the value obtained by subtracting the lower limit value i_{base} from the electric power consumption i is integrated with the determination electric power consumption i_{jdg}, the traveling state of the vehicle 10 is determined based on the determination electric power consumption i_{jdg}, and thus it is possible to more accurately determine the traveling state when the vehicle speed is high.

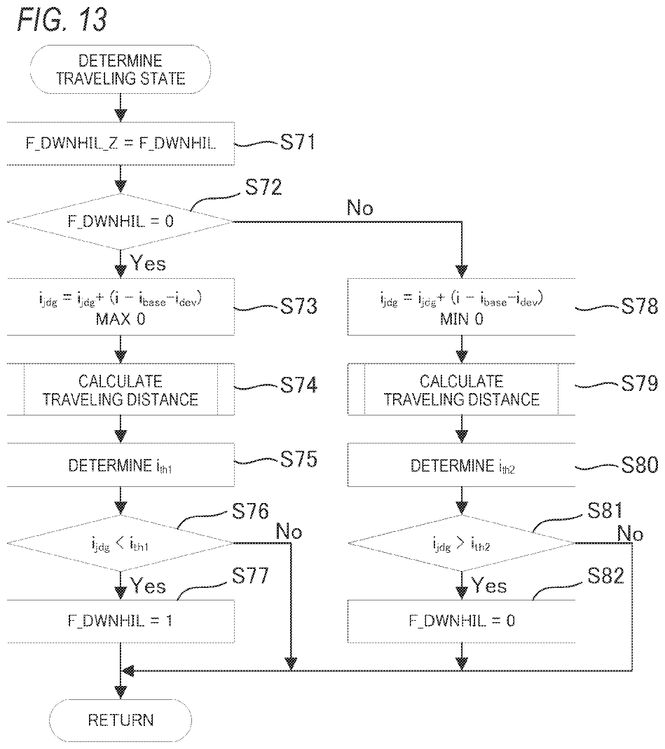

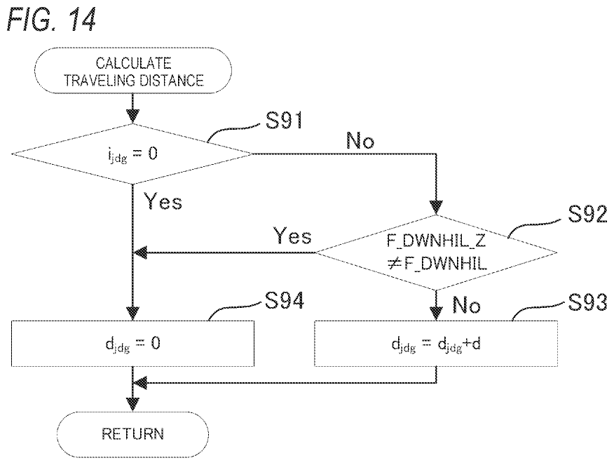

FIGS. 13 and 14 illustrate another modification of the traveling state determination process in the cruising range calculation process illustrated in FIGS. 9 and 10.

In the traveling state determination process, when the threshold values (the first threshold value iₜₕ₁ and the second threshold value iₜₕ₂) for the determination electric power consumption i_{jdg} are fixed values, a traveling distance until the determination electric power consumption i_{jdg} reaches each threshold value is long when a slope is gentle, and a traveling distance until the determination electric power consumption i_{jdg} reaches the threshold value is short when the slope is steep. Therefore, the detection of the shift from the non-downhill traveling state to the downhill traveling state or the shift from the downhill traveling state to the non-downhill traveling state is delayed when the slope is gentle as compared with the case where the slope is steep. In the traveling state determination process illustrated in FIGS. 13 and 14, a threshold value for the determination electric power consumption i_{jdg} is changed according to the traveling distance.

As illustrated in FIG. 13, the control device 22 holds the value of the state flag F_DWNHIL related to the traveling state of the vehicle 10 as the previous value in F_DWNHIL_Z (step S71). Then, the control device 22 acquires the traveling state of the vehicle 10 based on the value of the state flag F_DWNHIL (step S72).

When the traveling state of the vehicle 10 is the non-downhill traveling state (Yes in step S72), the control device 22 integrates a value obtained by subtracting the auxiliary device electric power consumption i_{dev} and the lower limit value i_{base} acquired in step S51 (see FIG. 9) from the electric power consumption i acquired in step S6 or step S7 (see FIG. 9) with the determination electric power consumption i_{jdg} in a range of zero or less (step S73).

Next, the control device 22 performs the traveling distance calculation process (step S74).

As illustrated in FIG. 14, in the traveling distance calculation process, the control device 22 determines whether the determination electric power consumption i_{jdg} is zero (step S91). When the determination electric power consumption i_{jdg} is less than zero or higher than zero (No in step S91), the control device 22 compares the value of the state flag F_DWNHIL with the previous value F_DWNHIL_Z of the state flag (step S92). When the value of the state flag F_DWNHIL and the previous value F_DWNHIL_Z of the state flag are the same (No in step S92), that is, when the traveling state of the vehicle 10 does not change, the control device 22 integrates the traveling distance d acquired in step S4 (see FIG. 9) with a determination traveling distance d_{jdg} (step S93).

On the other hand, when the determination electric power consumption i_{jdg} is zero (Yes in step S91), or when the value of the state flag F_DWNHIL is different from the previous value F_DWNHIL_Z of the state flag (Yes in step S92), that is, when the traveling state of the vehicle 10 shifts from the non-downhill traveling state to the downhill traveling state or shifts from the downhill traveling state to the non-downhill traveling state, the control device 22 resets the determination traveling distance d_{jdg} to zero (step S94).

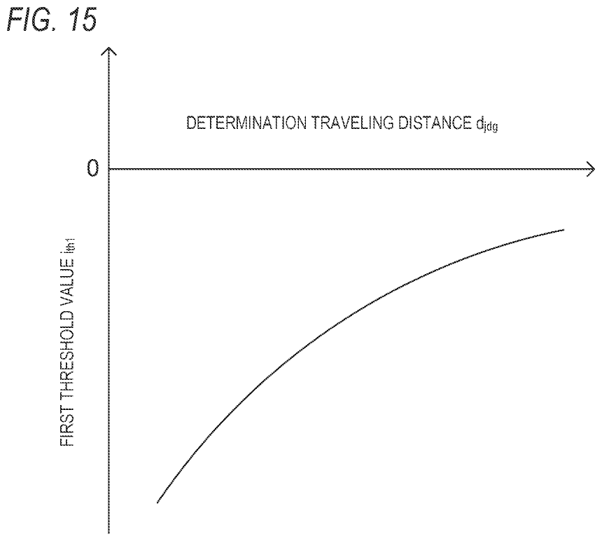

Referring again to FIG. 13, the control device 22 determines the first threshold value iₜₕ₁ according to the determination traveling distance d_{jdg} calculated in step S74 (step S75). The storage device of the control device 22 stores in advance a table which defines a relationship between the determination traveling distance d_{jdg} and the first threshold value iₜₕ₁. FIG. 15 illustrates an example of the table, in which the first threshold value iₜₕ₁ monotonically increases as the determination traveling distance d_{jdg} increases.

When the determination electric power consumption i_{jdg} is less than the first threshold value iₜₕ₁ (Yes in step S76), the control device 22 detects the shift from the non-downhill traveling state to the downhill traveling state, and sets the value of the state flag F_DWNHIL to “1” (step S77).

On the other hand, when the traveling state of the vehicle 10 is the downhill traveling state (No in step S72), the control device 22 integrates the value obtained by subtracting the auxiliary device electric power consumption i_{dev} and the lower limit value i_{base} acquired in step S51 (see FIG. 9) from the electric power consumption i acquired in step S6 or step S7 (see FIG. 9) with the determination electric power consumption i_{jdg} in a range of zero or more (step S78).

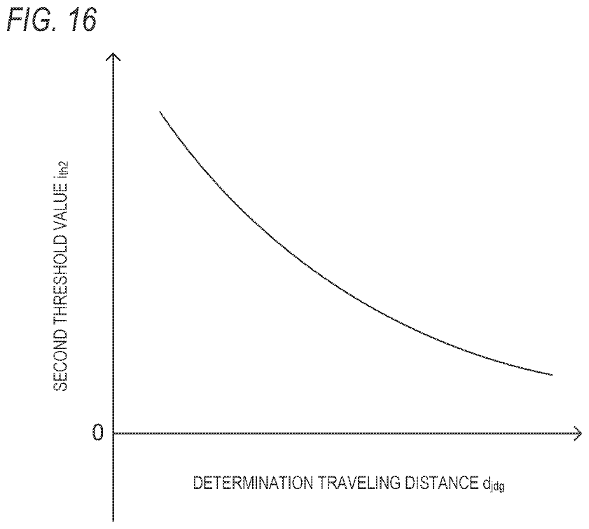

Next, the control device 22 performs the traveling distance calculation process illustrated in FIG. 14 (step S79). Subsequently, the control device 22 determines the second threshold value ilia according to the determination traveling distance d_{jdg} calculated in step S79 (step S80). The storage device of the control device 22 stores in advance a table which defines a relationship between the determination traveling distance d_{jdg} and the second threshold value iₜₕ₂. FIG. 16 illustrates an example of the table, in which the second threshold value iₜₕ₂ monotonically decreases as the determination traveling distance d_{jdg} increases.

When the determination electric power consumption i_{jdg} exceeds the second threshold value ilia (Yes in step S81), the control device 22 detects the shift from the downhill traveling state to the non-downhill traveling state, and sets the value of the state flag F_DWNHIL to “0” (step S82).

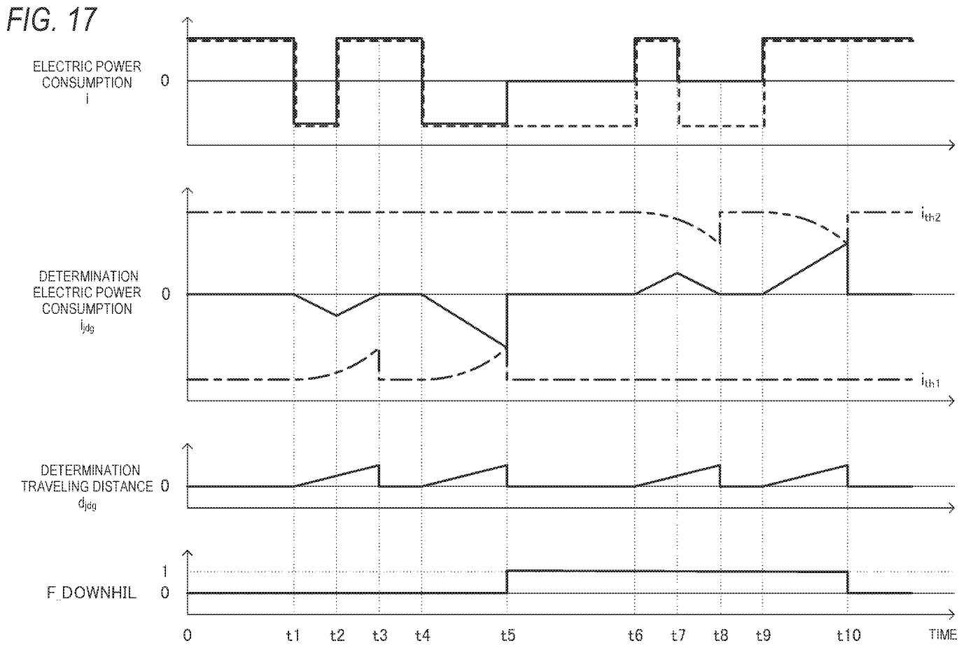

FIG. 17 is a timing chart illustrating the cruising range calculation process illustrated in FIGS. 9 and 10 according to the traveling situation of the vehicle. It is assumed that the traveling state determination process of step S52 is performed according to the modification illustrated in FIGS. 13 and 14. In a graph illustrating a change in the electric power consumption i per unit time, a solid line indicates the electric power consumption i after the limit is applied in step S54, and a broken line indicates the electric power consumption i acquired in step S6 or step S7.

During a period from time 0 to t4, the vehicle 10 travels on a level road, and the electric power consumption i acquired in step S6 or step S7 is basically a positive value, whereas during a period from time t1 to t2, the electric power consumption i is a negative value due to short-time deceleration or traveling on a relative short-distance downhill road. In addition, during a period from time t4 to t9, the vehicle 10 travels on a downhill road, and the electric power consumption i is basically a negative value, whereas during a period from time t6 to t7, the electric power consumption i is a positive value due to short-time acceleration or traveling on a relative short-distance uphill road. After the time t9, the vehicle 10 travels on a level road again.

In a period from the time t1 to t3 including the time t1 to t2 when the electric power consumption i is temporarily a negative value, the determination electric power consumption i_{jdg} obtained by integrating the electric power consumption i in a range of zero or less is less than zero. The traveling distance d acquired in step S4 is integrated with the determination traveling distance d_{jdg} over the period from the time t1 to t3, and the determination traveling distance d_{jdg} gradually increases. According to the increase in the determination traveling distance d_{jdg}, the first threshold value iₜₕ₁ in the above traveling state determination process increases. However, the determination electric power consumption i_{jdg} is not less than the first threshold value iₜₕ₁ but becomes zero at the time t3, and thus the determination traveling distance d_{jdg} is reset to zero.

After the time t4 when the electric power consumption i is constantly a negative value, the determination electric power consumption i_{jdg} obtained by integrating the electric power consumption i in a range of zero or less is less than zero again. The traveling distance d acquired in step S4 is integrated with the determination traveling distance d_{jdg}, and the determination traveling distance d_{jdg} gradually increases. According to the increase in the determination traveling distance d_{jdg}, the first threshold value iₜₕ₁ in the above traveling state determination process increases again. Then, at the time t5, the determination electric power consumption i_{jdg} is less than the first threshold value iₜₕ₁, and the shift to the downhill traveling state is detected.

In a period from the time t6 to t8 including the time t6 to t7 when the electric power consumption i is temporarily a positive value, the determination electric power consumption i_{jdg} obtained by integrating the electric power consumption i in a range of zero or more is higher than zero. The traveling distance d acquired in step S4 is integrated with the determination traveling distance d_{jdg} over the period from the time t6 to t8, and the determination traveling distance d_{jdg} gradually increases. According to the increase in the determination traveling distance d_{jdg}, the second threshold value iₜₕ₂ in the above traveling state determination process decreases. However, the determination electric power consumption i_{jdg} is not higher than the second threshold value iₜₕ₂ but becomes zero at the time t8, and thus the determination traveling distance d_{jdg} is reset to zero.

After the time t9 when the electric power consumption i is constantly a positive value, the determination electric power consumption i_{jdg} obtained by integrating the electric power consumption i in a range of zero or more is higher than zero again. The traveling distance d acquired in step S4 is integrated with the determination traveling distance d_{jdg}, and the determination traveling distance d_{jdg} gradually increases. According to the increase in the determination traveling distance d_{jdg}, the second threshold value iₜₕ₂ in the above traveling state determination process decreases again. Then, at the time t10, the determination electric power consumption i_{jdg} is higher than the second threshold value iₜₕ₂, and the shift to the non-downhill traveling state is detected.

As described above, the threshold values (the first threshold value iₜₕ₁ and the second threshold value iₜₕ₂) for the determination electric power consumption i_{jdg} change according to the traveling distance, so that the traveling distance until the determination electric power consumption i_{jdg} reaches each threshold value is shortened. Accordingly, for example, even when a slope of a downhill road is relatively gentle, it is possible to quickly detect the shift to the downhill traveling state, and even when a road following the downhill road is a level road, it is possible to quickly detect the shift to the non-downhill traveling state.

The above-described various processes performed by the control device 22 may be implemented by the control device 22 executing a program. Such a program can be provided by being recorded in a non-transitory computer-readable recording medium, and can also be provided by being downloaded via a network.

The present invention is not limited to the embodiments described above, and modifications, improvements, and the like can be made as appropriate.

In the present specification, at least the following matters are described. Constituent elements and the like corresponding to those according to the embodiments described above are shown in parentheses. However, the present invention is not limited thereto.

(1) A vehicle including:

an electric motor (MG) configured to rotate a driving wheel (DW) of the vehicle (10);

a power storage device (BAT) which is configured to supply electric power to the electric motor (MG) and is chargeable with electric power regenerated by the electric motor (MG); and

a control device (22) configured to calculate a cruising range of the vehicle (10) based on an electricity consumption of the vehicle (10) and a remaining electric power amount of the power storage device (BAT), and configured to execute a process of displaying the calculated cruising range, in which:

the control device (22) is configured to acquire an electric power consumption (i) and a traveling distance (d) of the vehicle (10) per unit time;

the control device (22) is configured to calculate the electricity consumption based on an integrated electric power consumption (I) obtained by integrating the electric power consumption (i) and an integrated traveling distance (D) obtained by integrating the traveling distance (d), and

the control device (22) is configured to determine whether a traveling state of the vehicle (10) is a downhill traveling state or a non-downhill traveling state, and the control device (22) is configured to limit improvement of the electricity consumption when the vehicle (10) is in the downhill traveling state.

(2) In the vehicle according to (1), when the vehicle (10) is in the downhill traveling state, the control device (22) is configured to calculate the electricity consumption by integrating a larger one of the electric power consumption (i) and a lower limit value (i_{base}) set for the electric power consumption (i) with the integrated electric power consumption (I).

(3) In the vehicle according to (2),

the control device (22) is configured to determine that the vehicle (10) is in the downhill traveling state when a first electric power amount integrated value (i_{jdg}), which is obtained by integrating a value obtained by subtracting the lower limit value (i_{base}) from the electric power consumption (i) in a range of zero or less in a period in which the vehicle (10) continues the non-downhill traveling state, is less than a first threshold value (i_{base}), and

the control device (22) is configured to determine that the vehicle (10) is in the non-downhill traveling state when a second electric power amount integrated value (i_{jdg}), which is obtained by integrating a value obtained by subtracting the lower limit value (i_{base}) from the electric power consumption (i) in a range of zero or more in a period in which the vehicle (10) continues the downhill traveling state, exceeds a second threshold value (iₜₕ₂).

(4) In the vehicle according to (2) or (3),

the control device (22) is configured to change the lower limit value (i_{base}) according to a vehicle speed.

(5) In the vehicle according to (4),

the control device (22) is configured to increase the lower limit value (i_{base}) as the vehicle speed increases.

(6) In the vehicle according to (3),

the control device (22) is configured to change the first threshold value (iₜₕ₁) according to a first distance integrated value (d_{jdg}) obtained by integrating the traveling distance (d) in a period in which the first electric power amount integrated value (i_{jdg}) is less than zero, and

the control device (22) is configured to change the second threshold value (iₜₕ₂) according to a second distance integrated value (d_{jdg}) obtained by integrating the traveling distance (d) in a period in which the second electric power amount integrated value (i_{jdg}) is larger than zero.

(7) In the vehicle according to (6),

the control device (22) is configured to increase the first threshold value (iₜₕ₁) as the first distance integrated value (d_{jdg}) increases, and is configured to decrease the second threshold value (iₜₕ₂) as the second distance integrated value (d_{jdg}) increases.

(8) A vehicle including:

an electric motor (MG) configured to rotate a driving wheel (DW) of the vehicle (10);

a power storage device (BAT) which is configured to supply electric power to the electric motor (MG) and is chargeable with electric power regenerated by the electric motor (MG); and

a control device (22) configured to calculate a cruising range of the vehicle (10) based on an electricity consumption of the vehicle (10) and a remaining electric power amount of the power storage device (BAT), and configured to execute a process of displaying the calculated cruising range, in which:

the control device (22) is configured to determine whether a traveling state of the vehicle (10) is a downhill traveling state or a non-downhill traveling state; and

the control device (22) is configured to reduce the cruising range calculated when in the downhill traveling state to less than the cruising range calculated when in the non-downhill traveling state with respect to the same remaining electric power amount of the power storage device (BAT).

(9) In the vehicle according to (8),

the control device (22) is configured to determine that the traveling state of the vehicle (10) is the downhill traveling state when an electric power consumption (i) per unit time of the vehicle (10) is less than a predetermined value.

(10) A method for calculating a cruising range of a vehicle including an electric motor (MG) configured to rotate a driving wheel (DW) of the vehicle (10) and a power storage device (BAT) which is configured to supply electric power to the electric motor (MG) and is chargeable with electric power regenerated by the electric motor (MG), the method including:

causing a computer (22) to perform:
acquisition of an electric power consumption (i) and a traveling distance (d) of the vehicle per unit time; and
calculation of an electricity consumption of the vehicle based on an integrated electric power consumption (I) obtained by integrating the electric power consumption (i) and an integrated traveling distance (D) obtained by integrating the traveling distance (d), in which

the calculation of the electricity consumption includes determining whether a traveling state of the vehicle (10) is a downhill traveling state or a non-downhill traveling state and limiting improvement of the electricity consumption when the vehicle (10) is in the downhill traveling state.

(11) In the method according to (10),

when the vehicle (10) is in the downhill traveling state, the calculation of the electricity consumption includes calculating the electricity consumption by integrating a larger one of the electric power consumption (i) and a lower limit value (i_{base}) set for the electric power consumption (i) with the integrated electric power consumption (I).

(12) A program configured to causes a computer to execute the method according to (10) or (11).

What is claimed is:

1. A vehicle comprising:
an electric motor configured to rotate a driving wheel of the vehicle;
a power storage device which is configured to supply electric power to the electric motor and is chargeable with electric power regenerated by the electric motor; and
a control device configured to calculate a cruising range of the vehicle based on an electricity consumption of the vehicle and a remaining electric power amount of the power storage device, and configured to execute a process of displaying the calculated cruising range, wherein:
the control device is configured to acquire an electric power consumption and a traveling distance of the vehicle per unit time;
the control device is configured to calculate the electricity consumption based on an integrated electric power consumption obtained by integrating the electric power consumption and an integrated traveling distance obtained by integrating the traveling distance; and
the control device is configured to determine whether a traveling state of the vehicle is a downhill traveling state or a non-downhill traveling state, and the control device is configured to limit improvement of the electricity consumption when the vehicle is in the downhill traveling state.

2. The vehicle according to claim 1, wherein
when the vehicle is in the downhill traveling state, the control device is configured to calculate the electricity consumption by integrating a larger one of the electric power consumption and a lower limit value set for the electric power consumption with the integrated electric power consumption.

3. The vehicle according to claim 2, wherein:
the control device is configured to determine that the vehicle is in the downhill traveling state when a first electric power amount integrated value, which is obtained by integrating a value obtained by subtracting the lower limit value from the electric power consumption in a range of zero or less in a period in which the vehicle continues the non-downhill traveling state, is less than a first threshold value; and
the control device is configured to determine that the vehicle is in the non-downhill traveling state when a second electric power amount integrated value, which is obtained by integrating a value obtained by subtracting the lower limit value from the electric power consumption in a range of zero or more in a period in which the vehicle continues the downhill traveling state, exceeds a second threshold value.

4. The vehicle according to claim 2, wherein
the control device is configured to change the lower limit value according to a vehicle speed.

5. The vehicle according to claim 4, wherein
the control device is configured to increase the lower limit value as the vehicle speed increases.

6. The vehicle according to claim 3, wherein:
the control device is configured to change the first threshold value according to a first distance integrated value obtained by integrating the traveling distance in a period in which the first electric power amount integrated value is less than zero; and
the control device is configured to change the second threshold value according to a second distance integrated value obtained by integrating the traveling distance in a period in which the second electric power amount integrated value is larger than zero.

7. The vehicle according to claim 6, wherein
the control device is configured to increase the first threshold value as the first distance integrated value increases, and is configured to decrease the second threshold value as the second distance integrated value increases.

8. A vehicle comprising:
an electric motor configured to rotate a driving wheel of the vehicle;
a power storage device which is configured to supply electric power to the electric motor and is chargeable with electric power regenerated by the electric motor; and
a control device configured to calculate a cruising range of the vehicle based on an electricity consumption of the vehicle and a remaining electric power amount of the power storage device, and configured to execute a process of displaying the calculated cruising range, wherein:
the control device is configured to determine whether a traveling state of the vehicle is a downhill traveling state or a non-downhill traveling state; and
the control device is configured to reduce the cruising range calculated when in the downhill traveling state to less than the cruising range calculated when in the non-downhill traveling state with respect to the same remaining electric power amount of the power storage device.

9. The vehicle according to claim 8, wherein
the control device is configured to determine that the traveling state of the vehicle is the downhill traveling state when an electric power consumption per unit time of the vehicle is less than a predetermined value.

10. A method for calculating a cruising range of a vehicle including an electric motor configured to rotate a driving wheel of the vehicle and a power storage device which is configured to supply electric power to the electric motor and is chargeable with electric power regenerated by the electric motor, the method comprising:
causing a computer to perform:
acquisition of an electric power consumption and a traveling distance of the vehicle per unit time; and
calculation of an electricity consumption of the vehicle based on an integrated electric power consumption obtained by integrating the electric power consumption and an integrated traveling distance obtained by integrating the traveling distance, wherein
the calculation of the electricity consumption includes determining whether a traveling state of the vehicle is a downhill traveling state or a non-downhill traveling state and limiting improvement of the electricity consumption when the vehicle is in the downhill traveling state.

11. The method according to claim 10, wherein
when the vehicle is in the downhill traveling state, the calculation of the electricity consumption includes calculating the electricity consumption by integrating a larger one of the electric power consumption and a lower limit value set for the electric power consumption with the integrated electric power consumption.

12. A program configured to cause a computer to execute the method according to claim 10.
